(19) United States
(12) Patent Application Publication
(10) Pub. No.: US 2002/0012728 A1
(43) Pub. Date: Jan. 31, 2002

(54) HYPOBARIC STORAGE DEVICE

(76) Inventors: DR. PETER CARLSON, CHEVY CHASE, MD (US); LAWRENCE P. KUNSTADT, ARDSLEY, NY (US)

Correspondence Address: ST. ONGE STEWARD JOHNSTON & REENS, LLC, 986 BEDFORD STREET, STAMFORD, CT, 06905-5619, US

(21) Appl. No.: 09/340,788

(22) Filed: Jun. 28, 1999

(51) Int. Cl. A23B 4/16; A23B 7/148

(52) U.S. Cl. 426/418; 426/419

(57) ABSTRACT

The present invention provides a cost-effective and convenient storage device which allows for the extended storage of all types of oxidizable materials, including foodstuffs such as fruits and vegetables; nonfoodstuffs such as plants, flowers, paper, cloth and leather; and inorganic materials such as oxidizable metals. The stored items are preserved solely through a reduction in air pressure, without a reduction of temperature, or the active addition and disposal of gases. This reduced-pressure storage allows stored foodstuffs to preserve their original taste without hardening, and organic nonfoodstuffs to be preserved without water condensation. Additionally, an optional step of humidifying the internal storage environment by means of a vessel inside or attached to the storage chamber and which delivers water vapor is provided. This relatively simple system functions with few components and mechanisms, thus providing a cost-effective and non-bulky design ideal either as a stand-alone unit or a component of another appliance.

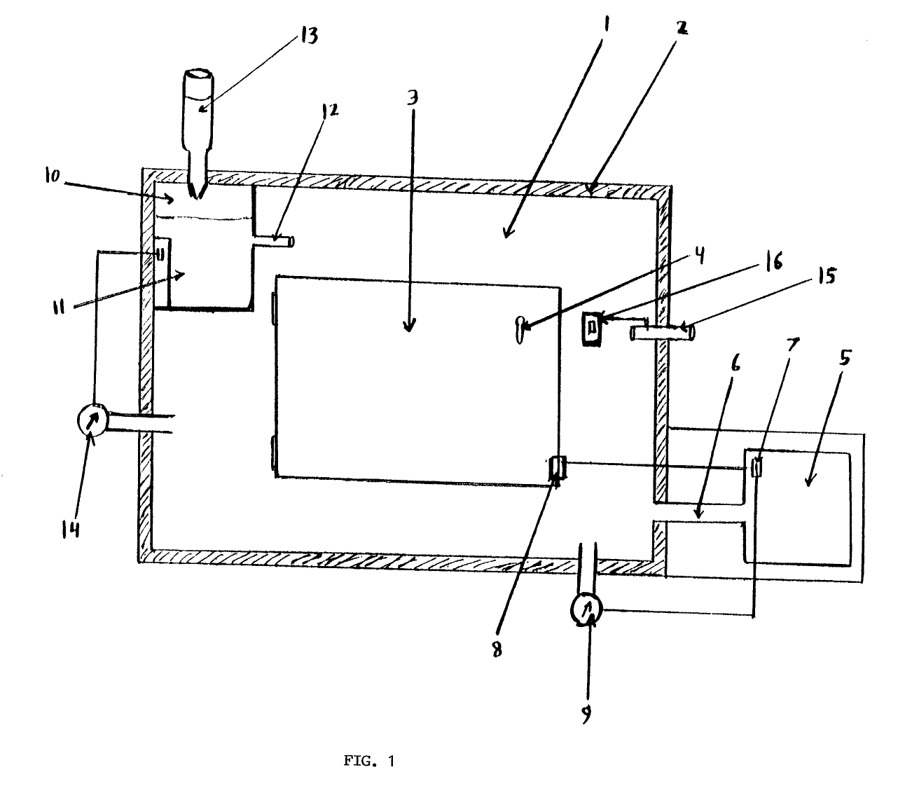

### FIELD OF THE INVENTION

The present invention relates to hypobaric, or reduced pressure storage devices, and more specifically relates to a small device which preserves oxidizable materials solely through a reduction in pressure, without refrigeration or the active addition and removal of gases. The items which may be stored in the device include foodstuffs such as fruits and vegetables; nonfood organic materials such as plants, flowers, paper, cloth and leather; and oxidizable inorganic materials such as coins.

### BACKGROUND OF THE INVENTION

Even with today's ubiquitous refrigeration technology, the storage and preservation of perishable goods such as foods poses a significant problem. There is an enormous degree of spoilage and disposal of foods in this and other countries. Due in part to the decreased use of pesticides and herbicides, the rate of loss of post-harvest crops due to spoilage is 5% to 25% in industrial nations and 20% to 50% in developing countries. In this country, the average consumer discards between 10% and 30% of fresh food before consumption due to spoilage. In addition, certain foods do not preserve well when refrigerated. Food companies and home economists recommend against refrigerating certain foods such as bananas. Additionally, many foods such as strawberries and lettuce spoil or desiccate (dry, shrivel and turn brown) even when refrigerated. Reduced temperature storage has the additional disadvantage of creating a hardening of the stored food items, especially in fruits and vegetables, with a resulting deterioration in taste.

Controlled storage of foods such as fruits and vegetables is necessary to significantly extend their edible life. The edible life of a fruit or vegetable is measured not only in the absence of deterioration, but in water retention and the preservation of appearance, taste, and nutritional quality. In addition, mature, fully ripe, or less than fully ripe fruit such as bananas, tomatoes, apples, and citrus fruits can be ripened more slowly under controlled conditions in a food storage or preservation apparatus.

Spoilage or deterioration of foods results from chemical oxidation such as self-decomposition or autolysis or decay resulting from the propagation of bacteria or fungi. Specifically in fruits and vegetables, the rate of deterioration or perishability is generally proportional to their respiration rate. Respiration is the overall process by which stored organic materials such as carbohydrates, proteins and fats are broken down into end products with the release of energy. Since respiration absorbs oxygen and releases carbon dioxide, reduction of oxygen to the respiring fruits and vegetables reduces the respiration rate and thus extends the life of the fruit or vegetable. Non-respiring organic material also degrades or oxidizes in an oxygen-rich environment, and this process of oxidation is slowed in a low-oxygen environment.

It is evident that there is a significant consumer need for better storage devices for the storage of fruits, vegetables and other foods which can overcome the limitations of refrigeration. Evidence of this need is demonstrated by the typical consumer's desire to stop the maturation of fruits and vegetables at the peak of ripeness as well as the common practice of food companies of picking fruits and vegetables in an unripe state in anticipation that they will ripen during transportation and later storage.

The problem of preserving nonfood oxidizable materials has also created a sizable commercial need. Organic materials such as paper, cloth and leather cannot be stored in a low temperature environment such as a refrigerator due to the problem of water condensation. It is common knowledge that archival materials such as rare books, manuscripts and old maps must not be exposed to heat, light or humidity in order to be preserved. It is also well-known that metals rust and that metal instruments and tools must be oiled from time to time in order to function properly. While the storage of archival materials such as rare books has been addressed by large walk-in controlled temperature and humidity rooms, there is currently no conveniently sized hypobaric appliance for the storage of these items on the market.

One major technological development addressing these needs is the use of modified atmospheres as a supplement to controlling temperature and humidity. One common technique of modifying atmospheres includes elevating carbon dioxide concentration within the internal storage chamber. However, these devices have addressed only large-scale pre-consumer industrial uses. One product sold in the 1970's which used modified atmospheres was an industrial size refrigerated unit, which was discontinued due to problems in cost, size and efficiency.

Another method of preserving foods or other perishable materials which avoids the disadvantages of refrigeration is storage with a reduction in air pressure. Generally, the preservation time of foods may be doubled through a reduction of air pressure to half the normal atmospheric pressure. However, scientific literature on low pressure storage written in the last twenty years has only addressed industrial size refrigeration storage devices which also reduce pressure. Currently, there is no low-cost, room temperature storage device on the market which functions solely through pressure reduction means.

One known low temperature/low pressure storage device provides correlated conditions of lower temperature, pressure, humidity and air movement for storing different categories of foods. An actively controlled humidifier provides a constant high relative humidity within the storage chamber and internal recirculation of air within the chamber facilitates rehumidification of the air. The air is humidified by contacting it with heated water from a supply. Pressure is maintained at a selected value slightly higher than the vapor pressure of the water. [Burg—U.S. Pat. No. 3,958,028]

Another storage device delays the ripening of edible picked fruits, so as to allow for transportation time, until such fruit is displayed to the consumer. Foodstuff is stored in a controlled moving gaseous stream, at subatmospheric pressures, so that undesirable gases generated during storage are flushed away. In addition, the moving gaseous stream is saturated with water to avoid desiccation or shrinkage of the fruit. The storage chamber is also refrigerated for optimal effect. [Burg—U.S. Pat. No. 3,333,967]

Another refrigerated storage device combines an open cycle system of refrigeration with a water-saturated air flow through a vacuum storage chamber. A pressure reducing means and vacuum pump for causing the flow of ambient air at subatmospheric pressure are provided. The flow of air vaporizes a body of liquid into the air within the chamber, and the expansion of air and evaporation of water creates a cooling effect conducive to tissue preservation. [Burg—U.S. Pat. No. 3,810,508]

Yet another storage device stores plant matter under reduced pressure and refrigerated temperature without the step of humidifying the storage atmosphere. Rather, the relative humidity in the storage chamber is kept close to saturation by moisture produced by the respiring plant matter. Air is evacuated from the cargo chamber at a rate correlated to the stored plant's type, weight and respiration rate at an optimal pressure and temperature. In addition, atmospheric air mixed with air within the storage chamber and the mixture is flowed over the plant matter. [Burg—U.S. Pat. No. 4,685,305]

These prior art storage devices are similar in that they are all walk-in, major industrial-size units which, due to their very large volume capacity, require active pumping in of desirable gases, such as carbon dioxide, the active removal of waste gases such as ethylene and refrigeration. Gases such as carbon dioxide must therefore be permanently stored in tanks or chambers in such devices, necessitating additional means for their safe handling. Additionally, since these prior art devices regulate temperature and pressure, as well as provide for air circulation, they require complex electrical and mechanical systems which greatly increases complexity and cost while decreasing the devices' versatility.

The reduction of temperature has the disadvantage of creating a hardening of the preserved organic materials which has a negative effect on the taste of the food. There is the possibility that cold temperatures generated by the refrigeration process will cause chilling damage to the foodstuff, specifically by the formation of ice on the food. In addition, storage devices which function by refrigeration typically require synthetic refrigerants which may be environmentally harmful.

Furthermore, all of these prior art devices are ideally suited for the storage and preservation of foods such as fruits and vegetables, or other types of plants and flowers. Nonfood organic materials such as paper, leather and cloth or inorganic materials such as metals are typically not stored in the prior art devices, where they would be damaged by the refrigeration. These storage units are also not suited for the storage of memorabilia or artifacts which are subject to oxidative degradation such as oxidizable metals, coins, cloth, flags, paper, archival books or rare manuscripts, stamps, photographs, and photographic negatives. Therefore, these prior art devices lack the versatility for the storage of all types of oxidizable materials.

### SUMMARY OF THE INVENTION

The present invention provides an inexpensive, convenient storage device for oxidizable materials which is preferably suited for home use. All types of oxidizable materials may be stored in the present device, including: foodstuffs such as meat, fish, poultry, dairy, fruits and vegetables; nonfood organic materials such as plants, flowers, paper, leather and cloth; and inorganic materials such as silver, nickel, and oxidizable metal alloys.

Preservation of oxidizable materials is achieved solely through a partial evacuation of air and a consequent reduction in oxygen pressure, without any reduction in temperature, and without any active addition or removal of gases. Since the present storage device is relatively small in size (preferably no larger than a small refrigerator) and contains a door which is relatively large compared to the size of the storage chamber, the active introduction of external gases and the active evacuation of gases produced by the stored materials are not necessary. The door opening preferably encompasses most of the surface area of the door side of the chamber similar, for example, to most home use microwave, oven or refrigerator doors. When the door is opened to put in or take out stored items, gaseous waste products of food respiration such as ethylene readily escape, facilitated by the inrush of fresh air. Humidification of the internal storage environment is optional, and may be supplied depending on the nature of material stored and length of time of storage.

The present invention consists of a storage chamber in which oxidizable materials are placed, and which is maintained at a reduced air pressure. The user of the device accesses the storage chamber through an access door which provides an airtight seal for the storage chamber when closed. During operation of the device, a means for reducing pressure creates a partial vacuum in the storage chamber. In a preferred embodiment of the invention, this pressure-reducing means is a vacuum pump which is attached to the storage chamber by an adjoining air conduit.

During operation, the vacuum pump evacuates air from the storage chamber, thus lowering the air pressure within the storage chamber to a selected or preset value. An electric control circuit connects the vacuum pump and the access door, so that the vacuum pump is turned on when the door is actively closed and remains on until the selected internal pressure is achieved. In one optional embodiment of the invention, before opening the door, the user depresses a button, opening a valve which equalizes the air pressure in the storage chamber with atmospheric pressure. An optional water reservoir or vessel is placed within or with access to the storage chamber, and water vapor is supplied so as to humidify the air within the chamber.

One advantage of the present storage device is its low cost operation due to its low electricity consumption. The storage device is preferably no larger than a small refrigerator, and its simplicity and lack of temperature-reduction enables it to run on a battery, a small generator or a manual electric-generating system. Simplicity of operation is also achieved due to its complete automation. The user need only open the door of the storage chamber, place the materials within the storage chamber and close the door to start the processing of the vacuum pump and the subsequent reduction in pressure in the chamber.

As a result of its ease of operation and low consumption of electricity, the storage device may be portable, and therefore beneficial to camping, hunting, fishing and other outdoor activities or military uses. The storage device may also provide a major humanitarian advantage to developing countries, since the major cause of starvation in these countries is not deficient agricultural production but lack of post-harvest preservation (20%-50% of crops are lost post harvest in these countries). At the same time, the present storage device is also ideal for the high fruit and vegetable diets of tropical countries.

### BRIEF DESCRIPTION OF THE DRAWING

The drawing is a diagrammatic cross-sectional view showing one embodiment of the present hypobaric storage device.

### DETAILED DESCRIPTION OF THE DRAWING

The drawing shows the present storage device with all of its functional components. A storage chamber 1 provides an internal space where oxidizable materials are stored. The housing walls 2 surrounding the storage chamber provide insulation against the leakage of air from the outside of the storage device to the inside of the storage chamber 1, and the consequent loss of the regulated internal pressure. In addition, the housing walls 2 provide insulation which prevents temperature extremes inside the storage chamber 1. The housing walls 2 are formed of a conventional material suitably adapted to be vacuumized.

The user's access to the storage chamber is through access door 3 which is opened and closed by pulling on a handle 4. The access door 3 provides a hermetically tight seal when closed so as to prevent air from leaking from outside the storage device into the storage chamber. The access door 3 should be large enough relative to the size of the storage chamber 1 so that when the access door is opened, waste gases generated by the stored items are easily dissipated and fresh air quickly enters into the storage chamber 1. In addition, a large access door provides the user with easy access to the stored items.

A vacuum mechanism 5 is connected to the storage chamber 1 by air conduit 6. The vacuum mechanism 5 evacuates air from the storage chamber 1 through the air conduit 6 to reduce the pressure within the storage chamber 1. The air pressure at which the storage chamber 1 is to be maintained is selected or altered in advance by the user or manufacturer, and this preselected value is electronically stored in a control circuit in the device. The optimal internal air pressure is dependant on factors such as the nature of the oxidizable material to be stored, the length of time of intended storage and degree of humidification of the internal storage environment.

In a preferred embodiment of the invention, the vacuum mechanism 5 is a vacuum pump which is placed outside the storage chamber (and preferably not directly abutting the storage chamber), so that the heat generated by the vacuum pump motor does not cause any temperature increase within the storage chamber 1. In an alternative embodiment, the vacuum pump may be placed inside the storage chamber 1, and further may be enclosed in an heat-absorbing or insulating material. In another alternative embodiment, the vacuum pump may be placed through the housing walls 2, so that the vacuum pump is partially inside and partially outside the storage chamber 1.

In an alternative embodiment of the invention, chemical means may be used to reduce the air pressure within the storage chamber 1. However, where a vacuum pump is used, it is preferably a lightweight super-charged water-seal or oil-seal pump. Where the weight of the storage device is not critical, other types of vacuum equipment may be suitable. Though a variety of brands of vacuum pumps may be used, the preferred vacuum pumps are those manufactured under the “Welch” brand name in the Sarvac, Director or Duroseal series, all of which are commercially available. Additional vacuum pump manufacturers are Precision Scientific, Gast and Labcon Co.

An air pressure sensor 9 is connected through an inlet to the storage chamber 1, and the air pressure sensor 9 detects the air pressure within the storage chamber 1. An optional air pressure gauge may be added which displays the detected air pressure value to the user. The preferred air pressure sensors and gauges are those manufactured under the “Welch” or “Edwards” brand names, and are commercially available.

In a preferred embodiment of the invention, the selected or preset air pressure to be maintained inside the storage chamber 1 is achieved through a regulating mechanism between the air pressure sensor 9 and the vacuum pump 5. A relay 7, which turns the vacuum mechanism 5 on or off, is electrically connected to the air pressure sensor 9. When the air pressure within the storage chamber 1, as read by the air pressure sensor, equals the selected or preset air pressure, a signal is sent to the relay 7 and the vacuum mechanism 5 is consequently turned off. If the air pressure in the storage chamber 1 increases in any considerable degree, the air pressure sensor 9 reads the new pressure value and turns the vacuum mechanism 5 on to reduce the air pressure back down to the preselected value.

In one embodiment of the invention, a pressure release valve 15 connects the air inside the storage chamber 1 with the air external to the storage device. The pressure release valve 15 remains closed during operation of the vacuum mechanism 5 as well as during closed-door storage of the oxidizable materials. A release button 16 is electrically connected to the pressure release valve 15. The release button 16 may be located anywhere on the storage device which is accessible to the user, but is preferably located near the door handle 4. In addition, the relay 7, which switches the vacuum mechanism 5 on or off, is electrically connected to a door sensor 8, located adjoining the access door 3.

Accessing the contents of this embodiment of the storage device requires the following steps. Before the user opens the access door 3, the user depresses the release button 16. This results in the opening of the pressure release valve 15, and allows for the flow of air into the storage chamber 1 and an equalization of air pressure between the inside of the storage chamber 1 and the external atmosphere. This equalization in air pressure occurs very rapidly (taking at most a second or two), after which time the access door 3 may be opened, and oxidizable materials removed from or added to the storage chamber 1. When the user closes the access door 3, the door sensor 8 detects the closed position and sends a signal to the relay 7, which turns the vacuum mechanism 5 back on. Evacuation of air through conduit 6 is resumed, and the pressure within the storage chamber 1 is reduced back to its selected or preset value.

In other embodiments, the storage device may be constructed without the pressure release valve and release button, but may comprise an electrically powered access door which is easy to open and which, when opened, allows for equalization of air pressure in the storage chamber with normal atmospheric pressure.

Humidifying the internal storage environment is optional depending on the nature of oxidizable materials stored, as well as intended period of time for storage. For example, for foodstuffs, maintenance of high humidity during hypobaric storage minimizes shrinkage, weight loss and desiccation of the food. The humidity may be adjusted from nearly 0 to a value high enough to prevent water loss—i.e., relative humidities between 90% and 95%—but not so high that water accumulates on the surface of the stored material. Though relative humidities of 80% are usefully permissible, the preferable relative humidity of the air in the storage chamber should be higher than approximately 90% for the storage of foodstuffs such as fruits and vegetables. For the storage of nonfoodstuffs such as paper, leather or cloth, the preferable relative humidity is between approximately 40% and 60%. For the storage of metals or metal instruments, the storage chamber 1 should not be humidified at all.

The air in the storage chamber 1 environment may be humidified through either active or passive means. The storage chamber 1 may be actively humidified by means of an electrically powered humidifier (not shown in the diagram), such as the commercially available ultrasonic humidifier. The humidifier is placed inside the storage chamber 1, and delivers water vapor into the storage chamber air once it is turned on by the user until the internal humidity reaches a relative humidity level selected by the user or preset by the manufacturer of the storage device. As a result of the evacuation of air by the vacuum pump, water vapor supplied by the humidifier will permeate throughout most of the storage environment.

Passive humidification, on the other hand, typically involves the following steps. A vessel or container 10 is secured either inside or outside the storage chamber 1 and is filled with water 11. The vessel 10 may be filled and refilled by the user by pouring water in a receiving container 13. In an alternative embodiment (not shown in the diagram), water may be delivered to the storage device through a pipe which is attached at one end to a house water supply (wherein such a delivery system is preferably similar to that of an ice-making feature in a conventional refrigerator). A water level sensor (not shown in diagram) may be added to the vessel 10. The water level sensor reads the water level of the vessel 10 and optionally signals the user to replenish the water supply when it is low.

The vessel 10 communicates with the storage chamber 1 through a nozzle 12, which is adapted to deliver water vapor into the air inside the storage chamber 1, preferably by vaporizing the water directly into the storage chamber environment. As air is evacuated from the storage chamber 1 through operation of the vacuum pump 5, water vapor is delivered through nozzle 12 into the storage chamber environment. As a result of the evacuation of air, the water vapor will permeate most of the internal storage environment.

Whether the storage chamber is humidified by active or passive means, the user or manufacturer of the present invention may preselect or set the humidity level to be maintained within the storage chamber 1. Optionally, a hygrometer 14 or similar humidity-detecting device may be installed so as to read the humidity inside the storage chamber 1. Hygrometers are commercially available, and the preferable models are manufactured by Taylor, Airguide and VWR. The hygrometer 14 may be electrically connected to the electrically-powered humidifier or the water-containing vessel 10. When the preselected humidity is achieved, the hygrometer will detect this value and either turn off the electrically-powered humidifier or close the moisture-delivery nozzle 12 in the vessel 10.

During operation of the storage device, the temperature remains at approximately room temperature. During closed door operation, the storage chamber does not undergo significant heat gain since any heat generated by the vacuum pump 5 is disposed of outside the storage device. Opening the door allows any slight temperature variances to equalize with the room temperature external to the storage device. An optional thermometer, or similar temperature sensor, (not shown in the diagram) may be installed in the storage device so as to read the internal temperature within the storage chamber 1.

The partial pressure of oxygen within the storage chamber 1 is proportional to the partial pressure of air within the storage chamber. For example, if the chamber is operated at 1/10 of an atmosphere rather than at normal atmospheric pressure (atmospheric pressure of air is 760 mm Hg), the partial pressure of oxygen is approximately 1/10 of its normal value in the atmosphere. Preferably, a partial vacuum is formed within the storage chamber at a pressure between 1/10 atmosphere to ⅓ atmosphere. The percentage content of oxygen in the air should be less than 10%, and preferably between 2% and 7%. At an oxygen level of less than 2%, food items begin to deteriorate.

One application of the present hypobaric storage device is for the controlled ripening of various nonripe fruits. For example, the ripening of bananas is delayed when the percentage content of oxygen in the air is kept below 21%. Ripening and aging processes are inhibited due to the fact that ethylene and other gases given out by the fruits are evacuated. At the ideal 2% to 7% oxygen range previously described, the ripening process of fruits is slowed considerably.

Another application of the present invention is extending the storage life of fully ripe or mature fruit, with “storage life” defined in terms of the characteristics of “at harvest” flavor, maintenance of appearance and/or firmness and absence of internal or external mold development or decay. The storage lives of fruits and vegetables may be increased between 50% and 100% over cold temperature storage. Approximate storage times for various fruits and vegetables in the present hypobaric storage device are given in the following table. These storage times may vary depending on the specific variety of fruit or vegetable stored as well as the degree of ripeness of the fruit or vegetable when placed in the storage chamber.

| | |
|---|---|
| Pineapple | 40 days |
| Grapefruit | 90-120 days |
| Strawberry | 21-28 days |
| Cherry | 60-90 days |
| Green pepper | 50 days |
| Cucumber | 41 days |
| Bean | 30 days |
| Onion | 15 days |
| Iceberg Lettuce | 40-50 days |
| Tomato | 60-100 days |
| Banana | 90-150 days |
| Avocado | 90-100 days |
| Lime | 60-90 days |
| Apples | 300 days |
| Pear | 300 days |

Yet another application for the present storage device is for the storage and preservation of nonfoodstuffs, both organic and inorganic. Nonfood organic materials include plants, flowers, paper, leather, cloth, wood, vellum, plant and animal derivatives, and parchment. Nonfood organic materials also include historical objects or memorabilia such as rare books, manuscripts, maps, flags, historical or archival documents, baseball cards, photographs and photographic negatives, stamps, and certain items of clothing. In addition, inorganic oxidizable materials such as coins, nails or tools will also benefit from storage in the present invention's low pressure environment. Storage of these items may be carried out in domestic, commercial, scientific, industrial or other settings, depending on the nature of the material to be stored. For example, a museum or library may use the present storage device to preserve historical artifacts or documents (though storage of these materials may be carried out in the home as well). Storage of foodstuffs, on the other hand, will likely be carried out in home environments.

In one embodiment, the present hypobaric storage device may be a stand-alone unit. In another embodiment, the storage device may be constructed as one component of a combination of appliances, and may be used in conjunction with these appliances. For example, the storage device may be attached to or placed within a cabinet, bookcase or safe for the storage of, for example, paper, vellum, old documents or manuals, rare books, manuscripts, maps, stamps, coin or other precious collections. The storage device may also be an independent unit, but constructed so as to be attachable to or used in conjunction with a refrigerator so as to allow either the refrigerated or room-temperature storage of all types of foods.

The enumerated lists of oxidizable materials which may be stored in the present device and the above table giving storage times for various fruits and vegetables are not intended to be exhaustive of the kinds of oxidizable matter that may be stored in the present invention or its possible applications. The foregoing description of the preferred embodiment of the invention has been presented for purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A reduced air pressure storage device for the preservation of oxidizable materials comprising:
a storage chamber having walls enclosing a storage space where oxidizable materials may be placed, and where air pressure is reduced relative to atmospheric pressure;
a door which provides access to the storage chamber;
a pressure-reducing mechanism which evacuates air from the storage chamber.

2. The reduced air pressure storage device of claim 1, wherein the pressure-reducing mechanism is a chemical process.

3. The reduced air pressure storage device of claim 1, wherein the pressure-reducing mechanism is a vacuum pump.

4. The reduced air pressure storage device of claim 3, wherein the vacuum pump is located outside the storage chamber and is connected to the storage chamber by a conduit.

5. The reduced air pressure storage device of claim 3, wherein the vacuum pump is located inside the storage chamber.

6. The reduced air pressure storage device of claim 3, wherein the vacuum pump is located partially inside and partially outside the storage chamber.

7. The reduced air pressure storage device of claim 3, wherein the vacuum pump is powered when the door is actively closed.

8. The reduced air pressure storage device of claim 1, wherein the air pressure within the storage chamber is equalized with atmospheric pressure before the door is opened.

9. The reduced air pressure storage device of claim 1, wherein the door is electrically powered.

10. The reduced air pressure storage device of claim 1, wherein the surface area of the door encompasses most of the surface area of the door side of the storage device.

11. The reduced air pressure storage device of claim 1, further comprising a mechanism for regulating the air pressure in the storage chamber according to an air pressure value selected by a user.

12. The reduced air pressure storage device of claim 1, further comprising a mechanism for regulating the air pressure in the storage chamber according to a preset air pressure value.

13. The reduced air pressure storage device of claim 1, further comprising a mechanism for humidifying the air inside the storage chamber.

14. The reduced air pressure storage device of claim 13, wherein the mechanism for humidifying the air inside the storage chamber comprises an electrically-powered humidifier.

15. The reduced air pressure storage device of claim 13, wherein the mechanism for humidifying the air inside the storage chamber comprises a liquid-containing vessel secured inside the storage chamber.

16. The reduced air pressure storage device of claim 13, wherein the mechanism for humidifying the air inside the storage chamber comprises a liquid-containing vessel attached to the outside of the storage device.

17. The reduced air pressure storage device of claim 13, wherein the mechanism for humidifying the air inside the storage chamber comprises a conduit attached to a water supply.

18. The reduced air pressure storage device of claim 13, wherein the mechanism for humidifying the air inside the storage chamber comprises a sponge.

19. The reduced air pressure storage device of claim 13, wherein the mechanism for humidifying the air inside the storage chamber comprises moisture-retaining walls which surround the storage chamber.

20. The reduced air pressure storage device of claim 13, wherein the relative humidity of the air inside the storage chamber is maintained at values higher than approximately 90%.

21. The reduced air pressure storage device of claim 13, wherein the relative humidity of the air inside the storage chamber is maintained at values of between approximately 40% and 60%.

22. The reduced air pressure storage device of claim 1, wherein the air pressure inside the storage chamber is maintained at values of between approximately 1/10 atmosphere and ⅓ atmosphere.

23. The reduced air pressure storage device of claim 1, wherein the oxygen content of the air inside the storage chamber is between approximately 2% and 7%.

24. The reduced air pressure storage device of claim 1, wherein the oxidizable materials to be stored are food items.

25. The reduced air pressure storage device of claim 1, wherein the oxidizable materials to be stored are nonfood organic materials.

26. The reduced air pressure storage device of claim 1, wherein the oxidizable materials to be stored are inorganic oxidizable materials.

27. The reduced air pressure storage device of claim 1, wherein the storage device is attached to or used in conjunction with another appliance.

28. The reduced air pressure storage device of claim 1, wherein the storage device is placed within another storage unit.

29. The reduced air pressure storage device of claim 1, wherein the storage device is a stand-alone unit.

30. A method of preserving oxidizable materials in a reduced air pressure environment comprising the steps of:
placing oxidizable materials inside a storage chamber having walls enclosing a storage space;
selecting an air pressure to be maintained within the storage chamber; and
operating a pressure-reducing mechanism to evacuate air from within the storage chamber in order to achieve the selected air pressure inside the storage chamber.

31. The method of claim 30, wherein the air pressure to be maintained within the storage chamber is preset.

32. The method of claim 30, with the further step of humidifying the air within the storage chamber with water vapor.
